(19) United States
(12) Patent Application Publication
(10) Pub. No.: US 2020/0178493 A1
(43) Pub. Date: Jun. 11, 2020

(54) System For A Toximeter, Having Inclined Separators

(71) Applicants: View Point, Civrieux (FR); Institut National De Recherche En Sciences Et Technologies Pour L'Environnement Et L'Agriculture, Antony (FR)

(72) Inventors: Arnaud Chaumot, Lyon (FR); Maxime Dauphin, Ceignes (FR); Alexandre Decamps, Saint-Gervais-Sur-Mare (FR); Olivier Geffard, Perigny (FR); Florian Moulin, Lyon (FR); Didier Neuzeret, Sainte Euphemie (FR)

(73) Assignees: View Point, Civrieux (FR); Institut National De Recherche En Sciences Et Technologies Pour L'Environnement Et L'Agriculture, Antony (FR)

(21) Appl. No.: 16/498,888

(22) PCT Filed: Mar. 29, 2018
(86) PCT No.: PCT/FR2018/050784

§ 371 Date: Sep. 27, 2019

(30) Foreign Application Priority Data
Mar. 30, 2017 (FR) 1752677

(51) Int. Cl. A01K 1/03; A01K 29/00

(52) U.S. Cl. CPC A01K 1/031; A01K 29/00

(57) ABSTRACT

A cage for the behavioural study of living organisms, in particular for a toximeter, includes at least one compartment intended to hold a living organism, the cage being transparent at least on an observation side in order to allow the observation of the living beings from an observation point located at a distance from the observation side, the compartment being delimited by separators, characterized in that the wall of one separator is inclined with respect to the wall of another separator such that the walls of the separators of a compartment are closer together in the direction of the observation side, said separators being aligned along convergence lines that meet at the observation point.

### CONTEXT AND TECHNOLOGICAL BACKGROUND

The present invention relates to the field of ethology or behavioral study of living organisms, in particular toxicology, and more particularly to the field of monitoring living beings in a toximeter.

In order to study the behavior of living organisms in a given environment, particularly the toxicity of a source of exposure, it is known to use living organisms generally chosen for their biomarker quality, i.e. their propensity to react to the environment, particularly in the presence of a toxic substance. Due to their ease of use and small size, small organisms such as arthropods are generally used. These organisms are exposed to the source of exposure, and their evolution is then analyzed to detect and possibly quantify the toxicity of the exposure.

One method of analysis consists in monitoring these living organisms throughout the duration of exposure to study their behavior and infer the toxicity of the exposure. To do this, an organism is placed in a transparent container at least on one observation side, and images of the container are acquired through the observation side by an imager placed opposite the observation side.

However, in the case of living beings, there is some uncertainty as to the reaction of the living organism to toxic exposure, or even the inevitable losses of these organisms. It is therefore necessary to study several living beings simultaneously and to make a statistical treatment of the results to smooth out these unknowns. However, it is generally not appropriate to place several living beings in the same container since organisms can then interfere with each other, which distorts the results of monitoring. In addition, it is very cumbersome and costly to provide a container and an imager for each monitored organism.

### PRESENTATION OF THE INVENTION

The purpose of the invention is to solve at least some of the above-mentioned disadvantages by proposing a behavioral study system, in particular in the form of a toximeter, allowing the detection of organisms that may be very small in size while limiting the number of imagers so that they can work at high resolution and/or high acquisition speed at a reasonable cost.

The invention is also preferably intended to provide a behavioral study system, in particular in the form of a toximeter, adapted to allow simultaneous monitoring of several living beings exposed to a source of toxicity, by allowing the acquisition of good quality images without analytical problems due to the conformation of the cage.

To this end, a system for studying the behavior of living organisms, in particular a toximeter, is proposed, comprising:
at least two cages, each cage comprising a plurality of compartments each intended to receive a living organism, each cage being transparent at least on one observation side in order to allow the observation of living beings from an observation point located at a distance from the observation side, the compartment being delimited by separators, the compartments being distributed next to each other on the observation side, the compartments being delimited between them by separators, a separator between two adjacent compartments having a wall in each of said adjacent compartments, the wall of one separator being inclined with respect to the wall of another separator so that the walls of the separators of one compartment are closer together in the direction of the observation side, said separators being aligned along convergence lines that meet at the observation point,
an imager located at the observation point of each cage,
   characterized in that the observation sides of said cages are substantially perpendicular to each other.

The skilled person will understand that the above-mentioned features of the invention make it possible to present an always identical background with respect to the observation point and thus to guarantee optimal detection and analysis, while guaranteeing a compactness of the system allowing to multiply the organisms studied.

The system for studying the behavior of living organisms forming, for example, a toximeter is advantageously complemented by the following features, taken alone or in any of their technically possible combinations:
the walls of one separator are inclined with respect to the walls of another separator so that the walls of said separator approach the walls of said other separator in the direction of the observation side, said separators being aligned along convergence lines that meet at the observation point;
the walls of the same separator between two adjacent compartments are inclined relative to each other towards the observation side, said walls being aligned along convergence lines that meet at the observation point;
the observation point is located at a distance of less than one meter from the observation side;
the cage includes a circuit for the circulation of fluid, for example water, through the compartments, the separators having openings to allow fluid communication between adjacent compartments;
the cage has a plurality of compartments facing an observation point, for example at least 9 compartments, and more preferably at least 16 compartments;
the system forming for example a toximeter comprises a cage arranged with a vertical observation side and a cage arranged with a horizontal observation side;
the system forming for example a toximeter forms a cube with three sides made up of a cage of the aforementioned type.

### PRESENTATION OF THE FIGURES

The invention will be better understood from the following description, which refers to embodiments and variants according to the present invention, given as non-limiting examples and explained with reference to the appended schematic drawings, wherein:

FIG. 1 schematically illustrates a section of a cage according to one possible embodiment of the invention,

FIG. 2 schematically illustrates a toximeter according to one possible embodiment of the invention.

### DETAILED DESCRIPTION

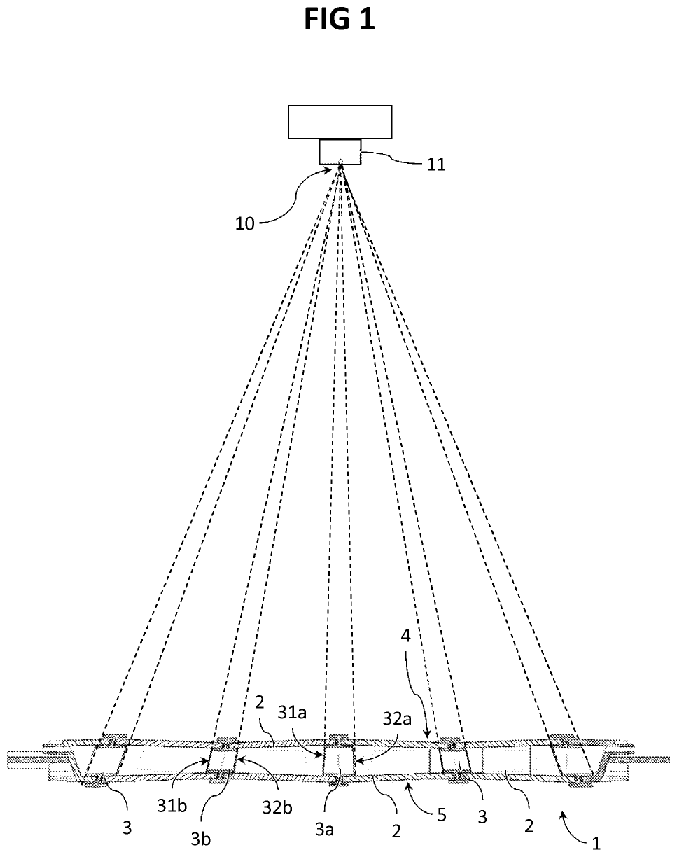

With reference to FIG. 1, the cage 1 preferably includes a plurality of compartments 2 each intended to receive a living organism. The compartments 2 are delimited by separators 3 between said compartments, and by two sides, including a transparent observation side 4. The observation side 4 allows the observation of living beings in the compartments 2 from an observation point 10 located at a distance from the observation side 4. The observation side is made of transparent polypropylene, for example. The cage 1 is particularly suitable for the observation of small aquatic creatures (mollusks, crustaceans, etc.) and the following description is made in this context.

It is understood that the transparency of the observation side 4 means that an observation can be made through this observation side 4. It is therefore possible that the observation side 4 is opaque to certain radiations, as long as an observation remains possible through this observation side 4. For example, the observation side 4 may be opaque to visible light, but allows observation by infrared or ultraviolet light, particularly by means of an appropriate imager. It is of course also possible that the observation side 4 allows observation through it to the naked eye of a user, such as in the case where the observation side 4 is transparent at visible wavelengths.

As indicated above, each compartment 2 is preferably intended to receive a living organism and a single living organism. However, as an alternative, each compartment 2 can accommodate several living organisms.

The compartments 2 are distributed next to each other on the observation side 4. Thus, the inside of each compartment 2 is visible from the observation point 10, through the observation side. The other side is a background side 5, which is opposite to the observation side 4. Thus, a compartment 2 is delimited by the observation side 4, the background side 5 and the separators 3. The separators extend between the observation side 4 and the background side 5.

A cage 1 may include several compartments 2, preferably evenly distributed in front of the observation point 10. The distribution of the compartments 2 can be configured in many ways. The different compartments 2 can be divided into a matrix of rows and columns, for example. The cage 1 can thus include at least 9 compartments 2 (distributed in the form of a matrix of 3 rows and 3 columns, for example), and preferably at least 16 compartments 2 (distributed in the form of a matrix of 4 rows and 4 columns, for example), regularly distributed in front of the observation point 10. For example, in a cage with 9 compartments organized in three rows of three compartments 2, the observation point 10 is preferably located in front of a central compartment 2. In a cage with 16 compartments organized in four rows of four compartments 2, the observation point 10 is preferably located opposite the intersection between the four central compartments 2. However, in the context of the invention, the matrix in rows and columns of the compartments 2 is not limited to a matrix with an equal number of rows and columns. The invention encompasses the row and column matrices of the compartments 2 wherein the number of rows is different from the number of columns.

The different compartments 2 can be distributed according to a flat or curved sheet. According to the invention, the different compartments can be arranged, for example, according to a flat sheet facing an observation point facing the center of the sheet. According to the invention, different flat sheets of inclined compartments, for example orthogonal pairs, can also be provided. It is thus possible to provide sheets which face one another and which have in their center an observation point associated with the sheet placed opposite thereto, for example 6 sheets arranged according to the sides of a cube and each with an observation point associated with the sheet opposite or 6 sheets arranged according to the sides of a cube and including a 360° multidirectional observation point arranged in the center of the cube. In general, the different sheets can be arranged according to the sides of a polyhedron, preferably regular, for example a tetrahedron, an octahedron, a dodecahedron, etc. The compartments 2 can also be provided arranged according to a spherical sheet and a 360° multidirectional observation point arranged in the center of the sphere.

The cage 1 may include a circuit for circulation of fluid, for example water, through several compartments 2. To that end, the separators 3 may include openings to allow fluid, for example water, to communicate between adjacent compartments 2, while preventing a living organism from one compartment 2 from passing through the separator 3 to another adjacent compartment 2, for example by means of grating. The fluid can then flow from one compartment 2 to another, but not the living beings.

The fluid can also be air depending on the chosen organisms, such as flying insects.

The compartments 2 may also contain organisms in agar or other transparent medium.

Each separator 3 between two adjacent compartments 2 has a wall 31, 32 in each of said adjacent compartments 2. The walls 31a, 32a of one separator 3a are inclined with respect to the walls 31b, 32b of another separator 3b so that the walls 31a, 32a of said separator 3a approach the walls 31b, 32b of said other separator 3b in the direction of the observation side 4, and therefore in the direction of the observation point 10.

More precisely, the separators 3 are aligned along convergence lines that meet at the observation point 10, when the cage is observed in cross-section along a plane containing the observation point 10, as shown in FIG. 1. The observation point 10 is therefore a vanishing point for the separators 3 of the cage 1. Thus, when the cage 1 is observed from the observation point 10, for example using an imager 11 at the observation point 10, the separators 3 do not mask the inside of the compartments 2 and the inside of each compartment 2 is then completely visible from the observation point 10. A living organism is then visible at all times whatever its movements in the compartment 2, even near the separators 3. In other words, thanks to the features of the invention, the observation point always sees an identical background.

Since the interiors of the compartments 2 can be observed from the same observation point 10, a single imager 11 is sufficient to monitor the activity of living organisms placed in the compartments 2, without the need for this imager 11 to have particular features in terms of size or width of acquisition field. It is also possible to use a cage 1 with a large observation side 4, thus allowing the observation of a large number of the compartments 2 at the same time.

In order to further improve the visibility of the interior of the compartments 2 from the observation point 10, the walls 31, 32 of the same separator 3 between two adjacent compartments 2 are preferably inclined relative to each other towards observation side 4 and therefore towards the observation point 10. The separator 3 therefore has a width that narrows towards the observation side 4 and therefore towards the observation point 10. More precisely, the walls 31, 32 of the same separator 3 can be aligned along convergence lines that meet at the observation point 10. This avoids the need to limit the width of the separators 3, since by a different inclination of each of its walls 31, 32, any masking of the compartments 2 adjacent to the separator 3 can be avoided.

In addition, the alignment of the separators 3 along convergence lines that meet at the observation point 10 allows a configuration wherein the observation point 10 can be close to the cage 1 without there being any problem of masking the compartments 2 by the separators 3. The observation point 10 may in particular be located at a distance of less than 1 meter from the observation side, and preferably the observation point 10 may be located at a distance of between 15 and 60 cm from the observation side 4. This significantly reduces the size of a toximeter comprising such a cage 1 and an imager 11 placed at the observation point 10. The imager 11 is typically a camera that periodically acquires images from the cage 1. The imager 11 allows observations to be made through the observation side 4. Therefore, the observation side 4 is transparent to the imager 11.

In order to further limit the size of the toximeter, advantage can be taken of the reduced distance between the observation point 10 and the observation side 4 by placing several cages 10 in different orientations sharing the same space between said cages 1 and their respective imagers located at each of the observation points 10 of said cages 1. In particular, the toximeter may include at least two cages 1 with substantially perpendicular observation sides 4, for example with a first cage 1 arranged with a substantially vertical observation side 4 and a second cage 1 arranged with a substantially horizontal observation side 4.

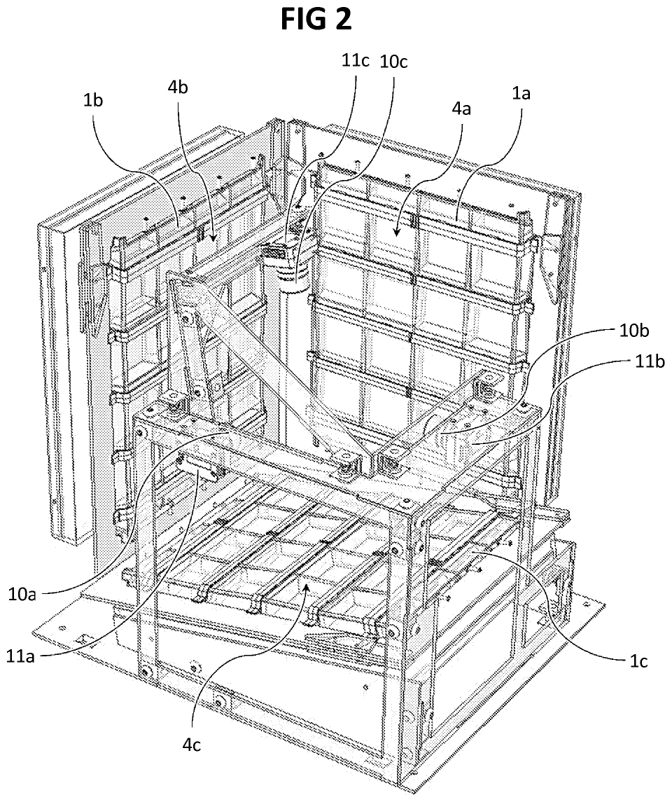

FIG. 2 schematically illustrates a toximeter consisting of a cube with three sides made up of a cage 1. The toximeter therefore includes three cages 1a, 1b, 1c. The respective observation sides 4a, 4b, 4c of these cages are oriented towards the inside of the cube forming the toximeter. Imagers 11a, 11b, 11c are arranged at each observation point 10a, 10b, 10c of the respective cages 1a, 1b, 1c. Each observation point 10a, 10b, 10c is located, with respect to the observation side 4a, 4b, 4c of its cage 1a, 1b, 1c, in a direction of an open side of the cube, i.e. a side without cage 1. Thus, the imagers 11a, 11b, 11c for one cage 1a, 1b, 1c do not interfere with the observation of another cage 1. Preferably, the observation points 10a, 10b, 10c are located at the open sides of the cube. The toximeter then includes a cube with three sides formed by a cage 1, and three sides each formed by an imager 11 placed at the observation point 10 of the cage 1 on the opposite side of the cube.

As shown in FIG. 2, the cages 1a, 1b, 1c are substantially perpendicular to each other, and therefore their observation sides 4a, 4b, 4c are also substantially perpendicular. Two cages 1a, 1bare arranged with substantially vertical observation sides 4a, 4b, while the third cage 1c is arranged with a substantially horizontal observation side 4c. It should be noted, however, that this third cage 1c is preferably slightly inclined with respect to the horizontal, in order to allow gravity displacement of suspended matter with respect to the bottom side 5 of the cage 1c. However, this inclination remains small and does not exceed 30° from the horizontal.

In addition to the cages 1 and the imagers 11, a toximeter can typically include various operating elements such as measuring devices (luxmeter, thermometer, etc.) to ensure that living beings are kept alive, and actuators such as water circulation pumps or cooling or heating units.

The invention is not limited to the embodiment described and represented in the accompanying figures. Changes remain possible, in particular with regard to the constitution of the various technical features or by substitution of technical equivalents, without however leaving the scope of protection of the invention.

In particular, the invention is not limited to the production of a toximeter intended for the study of the toxicity of components or for the detection of contaminants. The invention also applies, for example, to the production of devices for the study of behavioral responses to various stimuli, such as vibrations, light, temperature, etc.

1. A system for studying the behavior of living organisms, in particular a toximeter, comprising:
at least two cages, each cage comprising a plurality of compartments each intended to receive a living organism, each cage being transparent at least on one observation side in order to allow the observation of living beings from an observation point located at a distance from the observation side, the compartments being distributed next to each other on the observation side, the compartments being delimited between them by separators, a separator between two adjacent compartments having a wall in each of said adjacent compartments, the wall of one separator being inclined with respect to the wall of another separator so that the walls of the separators of a compartment are closer together in the direction of the observation side, said separators being aligned along convergence lines that meet at the observation point,
an imager located at the observation point of each cage,
wherein the observation sides of said cages are substantially perpendicular to each other.

2. The system according to claim 1, wherein the walls of one separator are inclined with respect to the walls of another separator so that the walls of said separator approach the walls of said other separator towards the observation side, said separators being aligned along convergence lines that meet at the observation point.

3. The system according to claim 1, wherein the walls of the same separator between two adjacent compartments are inclined relative to each other towards the observation side, said walls being aligned along convergence lines that meet at the observation point.

4. The system according to claim 1, wherein each observation point is located at a distance of less than one meter from the observation side.

5. The system according to claim 1, comprising a circuit for the circulation of fluid, for example water, through the compartments, the separators having openings to allow fluid communication between adjacent compartments.

6. The system according to claim 1, wherein the system comprises several cages arranged according to flat or curved sheets, each sheet comprising several compartments regularly distributed in front of an observation point, preferably in the form of a matrix of rows and columns.

7. The system according to claim 1, wherein a cage is arranged with a vertical observation side and a cage is arranged with a horizontal observation side.

8. The system according to claim 1, forming a cube with three sides consisting of a cage.
